(19) United States
(12) Patent Application Publication
(10) Pub. No.: US 2024/0055688 A1
(43) Pub. Date: Feb. 15, 2024

(54) Heat Dissipation Member and Battery Pack Including Same

(71) Applicant: LG Energy Solution, Ltd., Seoul (KR)

(72) Inventors: Doohan Yoon, Daejeon (KR); Changkeun Son, Daejeon (KR)

(73) Assignee: LG Energy Solution, Ltd., Seoul (KR)

(21) Appl. No.: 18/267,494

(22) PCT Filed: Sep. 1, 2022
(86) PCT No.: PCT/KR2022/013134

§ 371 Date: Jun. 15, 2023

(30) Foreign Application Priority Data
Nov. 15, 2021 (KR) 10-2021-0156869

(51) Int. Cl. H01M 10/613; H01M 10/653; A62C 3/16; H01M 10/6551; H01M 10/658

(52) U.S. Cl. CPC H01M 10/613; H01M 10/653; A62C 3/16; H01M 10/6551; H01M 10/658

(57) ABSTRACT

A heat dissipation member includes a heat dispersion member including a first heat dispersion part and a second heat dispersion part, and a heat insulating member formed along an outer surface of the heat dispersion member.

### CROSS-REFERENCE TO RELATED APPLICATIONS

The present application is a national phase entry under 35 U.S.C. § 371 of International Application No. PCT/KR2022/013134 filed Sep. 1, 2022, which claims the benefit of Korean Patent Application No. 10-2021-0156869 filed on Nov. 15, 2021 with the Korean Intellectual Property Office, the entire contents of which are incorporated herein by reference.

### TECHNICAL FIELD

The present disclosure relates to a heat dissipation member and a battery pack including the same, and more particularly to a heat dissipation member that can effectively dissipate heat while preventing heat propagation between adjacent battery modules.

### BACKGROUND ART

As mobile device technology continues to develop and demand therefor continues to increase, demand for secondary batteries as energy sources is rapidly increasing. In particular, a secondary battery has attracted considerable attention as an energy source for power-driven devices, such as electric bicycles, electric vehicles, and hybrid electric vehicles, as well as an energy source for mobile devices, such as mobile phones, digital cameras, laptop computers, and wearable devices.

In small mobile devices, one, two, or three battery cells are used per device, while middle or large-sized devices, such as vehicles, require batteries with high power and a large capacity. Therefore, a middle or large-sized battery module having a plurality of battery cells electrically connected to one another is used for large-sized devices.

Since it is preferable for middle or large-sized battery modules to be manufactured with increasingly smaller sizes and weights, a prismatic battery, a pouch-type battery, or the like, is mainly used because these batteries can be stacked with high integration and have a low weight relative to their capacity.

Existing battery packs may include a plurality of battery modules. When a part of the battery cells of the respective battery modules is thermally runaway in a manner causing it to ignite or explode, heat or flame is transferred to the adjacent secondary battery, which may cause a secondary ignition or explosion. Thus efforts to prevent secondary ignition or explosion have increased.

Therefore, there is a need to develop a heat dissipation member that can effectively dissipate generated heat while preventing heat transfer to adjacent battery modules when some battery modules in a battery pack ignite and then explode.

### DISCLOSURE

### Technical Problem

The present disclosure is designed to provide a heat dissipation member that can effectively dissipate heat while preventing heat propagation between adjacent battery modules. Such a heat dissipation member may be implemented in a battery pack.

The problem to be solved by the embodiments of the present disclosure is not limited to the above-described problems, and can be expanded within the scope of the technical idea included in the present disclosure.

### Technical Solution

According to one embodiment of the present disclosure, there is provided a heat dissipation member comprising: a heat dispersion member including a first heat dispersion part and a second heat dispersion part; and a heat insulating member formed along an outer surface of the heat dispersion member.

The first heat dispersion part and the second heat dispersion part are integrally formed, and the first heat dispersion part and the second heat dispersion part may be formed so as to be partially spaced apart from each other.

The first heat dispersion part and the second heat dispersion part are respectively bent and extended, and the directions in which the first heat dispersion part and the second heat dispersion part are bent may be directions opposite to each other.

The heat dissipation member may further comprise a first depressed part formed in the first heat dispersion part, and a second depressed part formed in the second heat dispersion part.

The heat dissipation member may further comprise a cooling member formed in the first depressed part and the second depressed part.

The heat dissipation member may further comprise a first indented part formed in the first heat dispersion part; and a second indented part formed in the second heat dispersion part, wherein the first indented part and the second indented part may be formed so as to contact each other.

According to another embodiment of the present disclosure, there is provided a battery pack comprising: a plurality of battery modules; and a heat dissipation member located between adjacent battery modules among the plurality of battery modules, wherein the heat dissipation member comprises a heat dispersion member including a first heat dispersion part and a second heat dispersion part; and a heat insulation member formed along an outer surface of the heat dispersion member.

The heat insulation member may be formed between the heat dispersion member and the battery module.

The heat insulation member may be formed so as to be in contact with the battery module.

In the battery pack, the first heat dispersion part and the second heat dispersion part are integrally formed, and the first heat dispersion part and the second heat dispersion part may be formed so as to be partially spaced apart from each other

In the battery pack, the first heat dispersion part and the second heat dispersion part are respectively bent and extended, and the directions in which the first heat dispersion part and the second heat dispersion part are bent may be directions opposite to each other.

The battery pack further comprises a first indented part formed in the first heat dispersion part; and a second indented part formed in the second heat dispersion part, wherein the first indented part and the second indented part may be formed so as to contact each other.

The battery pack may further comprise a first depressed part formed in the first heat dispersion part, and a second depressed part formed in the second heat dispersion part.

The battery pack may further comprise a cooling member formed in the first depressed part and the second depressed part.

The battery pack further comprise a pack frame that houses the plurality of battery modules, wherein the cooling member may be in contact with the upper part of the pack frame.

The cooling member may be in contact with the upper inner surface of the pack frame.

The battery pack according to yet another embodiment of the present disclosure may further comprise a thermal conductive resin layer formed between a lower part of the battery module and a bottom part of the pack frame.

The battery pack may further comprise a heat sink formed between a lower part of the thermal conductive resin layer and a bottom part of the pack frame.

### Advantageous Effects

According to an embodiment of the present disclosure, in the heat dissipation member and battery pack including the same, the heat dispersion member included in the heat dissipation member is located between heat insulation members, and a separation space is formed between the respective heat dispersion members. This arrangement effectively dissipates heat while preventing heat propagation between the battery modules.

The effects of the present disclosure are not limited to the effects mentioned above and additional other effects not described above will be clearly understood by those skilled in the art from the detailed description and the appended drawings.

### DESCRIPTION OF THE DRAWINGS

FIG. 1 is a perspective view of a heat dissipation member according to one embodiment of the present disclosure;

FIG. 2 is a perspective view of a heat dispersion member included in the heat dissipation member of FIG. 1;

FIG. 3 is side view of the heat dispersion member of FIG. 2;

FIG. 4 is a side view of a heat dispersion member coupled to a heat dissipation member of FIG. 1 included in a heat insulation member.

FIG. 5 is side view of a heat dissipation member coupled to a cooling member to the heat dispersion member and the heat insulation member of FIG. 4;

FIG. 6 is a cross section view of a battery pack according to another embodiment of the present disclosure;

FIG. 7 is a cross section view of a battery pack according to another embodiment of the present disclosure; and

FIG. 8 is a perspective view of a battery module included in the battery pack of FIGS. 6 and 7.

### DETAILED DESCRIPTION OF THE PREFERRED EMBODIMENTS

Hereinafter, various embodiments of the present disclosure will be described in detail with reference to the accompanying drawings so that those skilled in the art can easily ascertain the various embodiments. The present disclosure may be modified in various ways, and it is not limited to the embodiments set forth herein.

Portions that are irrelevant to the description will be omitted to clearly describe the present disclosure, and like reference numerals designate like elements throughout the description. Further, in the drawings, the size and thickness of each element are arbitrarily illustrated for convenience of description, and the present disclosure is not necessarily limited to the embodiments illustrated in the drawings, including details such as the sizes and thicknesses of each element as illustrated in the drawings.

In addition, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, the word “on” or “above” includes arrangements on or below a reference portion, and does not necessarily mean being arranged on the upper end of the reference portion toward the opposite direction of which a gravitational force acts on the object.

Further, throughout the description, when a portion is referred to as “including” a certain component, it means that the portion can further include other components, without excluding the other components, unless otherwise stated.

The terms “first,” “second,” etc. are used to explain various components, but the components should not be limited by the terms. These terms are only used to distinguish one component from the other component.

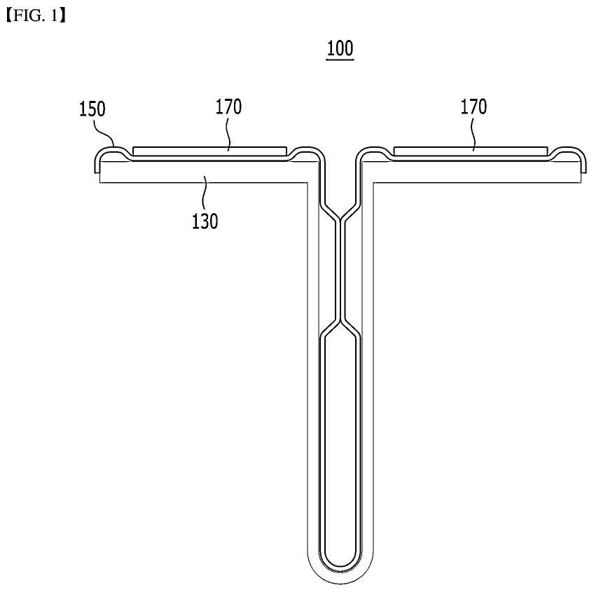

Hereinafter, a heat dissipation member according to one embodiment of the present disclosure will be described with reference to FIGS. 1 to 5.

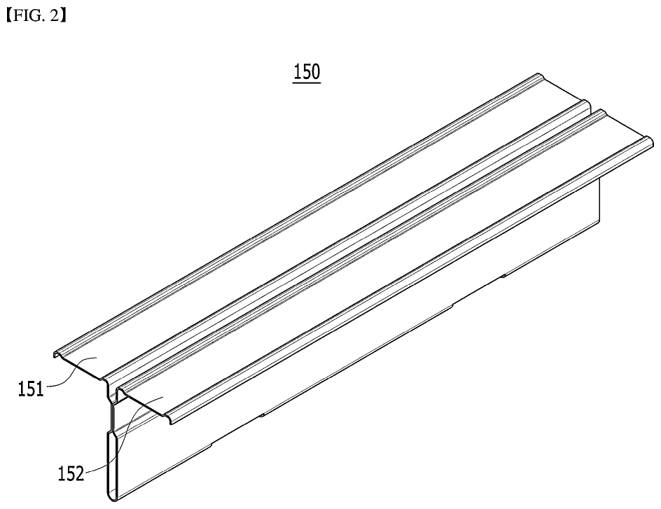

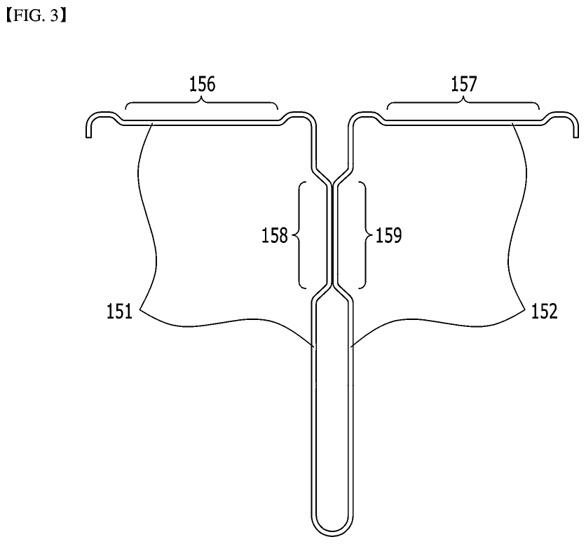

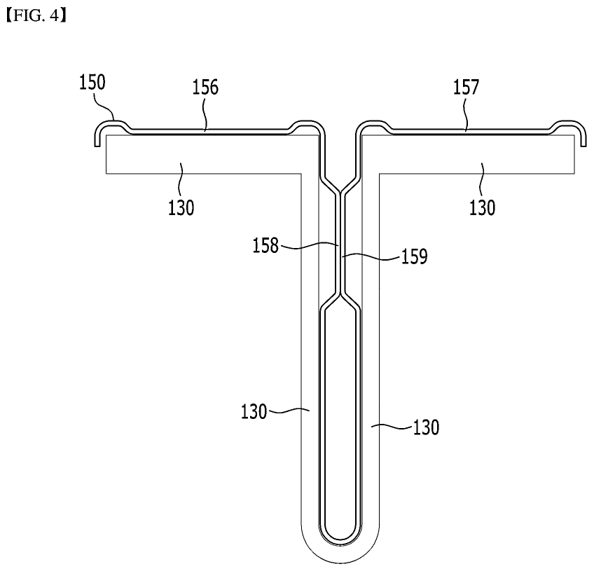

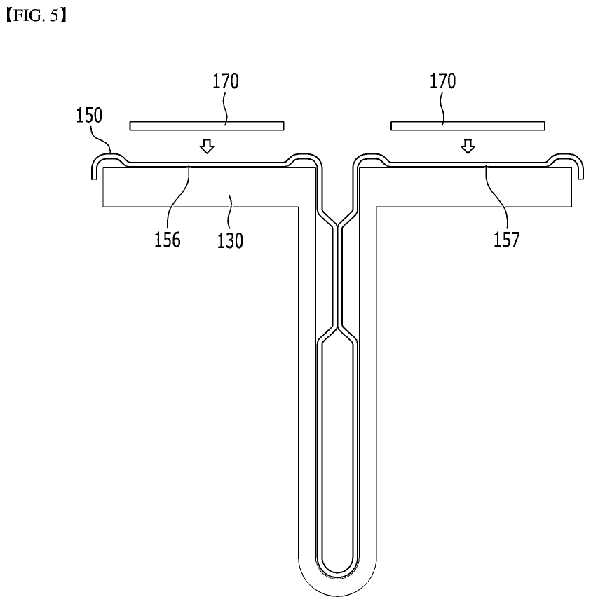

FIG. 1 is a side view showing a heat dissipation member according to one embodiment of the present disclosure. FIG. 2 is a perspective view showing a heat dispersion member included in the heat dissipation member of FIG. 1. FIG. 3 is a side view showing a the heat dispersion member of FIG. 2. FIG. 4 is side view showing a state in which a heat dispersion member and a heat insulation member included in the heat dissipation member of FIG. 1 are coupled. FIG. 5 is a side view showing a state in which a cooling member to the heat dispersion member and the heat insulation member of FIG. 4 are coupled to form a heat dissipation member.

Referring to FIGS. 1 and 2, the heat dissipation member 100 according to the present embodiment may include a heat dispersion member 150 including a first heat dispersion part 151 and a second heat dispersion part 152.

The heat dispersion member 150 may include a first heat dispersion part 151 and a second heat dispersion part 152 that are integrally formed. The first heat dispersion part 151 and the second heat dispersion part 152 may be formed so as to be partially spaced apart from each other. Therefore, a space may be formed between the first heat dispersion part 151 and the second heat dispersion part 152.

The first heat dispersion part 151 and the second heat dispersion part 152 may be respectively bent and extended, and the directions in which the first heat dispersion part 151 and the second heat dispersion part 152 are bent may be directions opposite to each other. Specifically, the first heat dispersion part 151 may refer to the left area with respect to the center of the heat dispersion member 150 (see FIG. 2), and the second heat dispersion part 152 may refer to the right area. Therefore, as being away from a heat dispersion member 150 in which the first heat dispersion part 151 and the second heat dispersion part 152 are integrated, the first heat dispersion part 151 and the second heat dispersion part 152 may have bent portions. Therefore, as being bent as described above, the first heat dispersion part 151 and the second heat dispersion part 152 may have portions bent and extended in directions opposite to each other.

Referring to FIGS. 2 and 3, the heat dissipation member 100 according to the present embodiment may further include a first depressed part 156 formed in the first heat dispersion part 151, and a second depressed part 157 formed in the second heat dispersion part 152. The first depressed part 156 may be formed in the bent and extended portion of the first heat dispersion part 151, and the second depressed part 157 may be formed in the bent and extended portion of the second heat dispersion part 152.

Further, the heat dissipation member 100 may further include a first indented part 158 formed in the first heat dispersion part 151 and a second indented part 159 formed in the second heat dispersion part 152. The first indented part 158 and the second indented part 159 may be formed adjacent to the lower end of the heat dispersion member 150 where the first heat dispersion part 151 and the second heat dispersion part 152 are integrated. In particular, the first indented part 158 and the second indented part 159 may be formed to contact each other. As the first indented part 158 and the second indented part 159 contact each other, heat transferred to the first heat dispersion part 151 or the second heat dispersion part 152 can be rapidly transferred to the other of the second heat dispersion part 152 or the first heat dispersion part 151. Thus, the heat dissipation performance of the heat dispersion member 150 can be improved by forming an additional heat transfer path in the heat dispersion member 150, together with a heat transfer path through the lower end of the heat dispersion member 150 where the first heat dispersion part 151 and the second heat dispersion part 152 are integrated.

Referring to FIG. 5, the heat dissipation member 100 of FIG. 2 according to the present embodiment may further include a cooling member 170 formed in the first depressed part 156 and the second depressed part 157. The cooling member 170 may be a cooling pad. The cooling pad may be formed of a silicon-based or acrylic-based material. Specifically, the cooling pad may be a silicone pad, a silicone rubber pad, a silicone polymer pad, an acrylic pad, an acrylic polymer pad, or the like, but is not limited thereto. The cooling member 170 can cool the heat transferred from the heat dispersion member 150 of the heat dissipation member 100.

Referring to FIGS. 4 and 5, the heat dissipation member 100 according to the present embodiment may include a heat insulation member 130 that is formed along the outer surface of the heat dispersion member 150. Specifically, the heat insulation member 130 may be formed at a point along the outer surface of the heat dispersion member 150. More specifically, the heat insulation member 130 may be formed on the outer surface of the lower end of the bent and extended portion of the outer surface of the heat dispersion member 150.

The heat insulation member 130 may not be formed on the inner surface of the heat dispersion member 150. A space formed between the first heat dispersion part 151 and the second heat dispersion part 152 of the heat dispersion member 150 may be referred to as an inner surface of the heat dispersion member 150. Therefore, the heat insulation member 130 may not be formed on the inner surface of the heat dispersion member 150. This arrangement may facilitate heat transfer between the first heat dispersion part 151 and the second heat dispersion part 152 of the heat dispersion member 150. In particular, since the heat insulation member 130 may serve to block the heat propagation of heat moved from one of the heat dispersion parts 151 and 152, the movement of the transferred heat to the other heat dispersion parts 152 and 151 may act as a disturbing factor. Therefore, when the heat insulation member 130 according to the present embodiment is not formed on the inner surface of the heat dispersion member 150, heat transfers between the first heat dispersion part 151 and the second heat dispersion part 152.

The portion where the heat insulation member 130 is formed may be a portion that is in contact with the module frame 18 of the battery module 10 as will be described later. Therefore, due to the configuration of the heat insulation member 130, it is possible to effectively dissipate the generated heat while preventing heat transfer to adjacent battery modules 10 if the battery module 10 catches fire.

In addition, the heat dispersion member 150 may be made of a material such as aluminum (Al) or graphite. However, the material of the heat dispersion member 150 is not limited thereto, and any material having high thermal conductivity may be included in the present embodiment.

Further, the heat insulation member 130 may include a ceramic material. In one example, the ceramic material may include ceramic fibers. However, the material of the heat insulation member 130 is not limited thereto, and any material having high heat insulating properties may be included in the present embodiment.

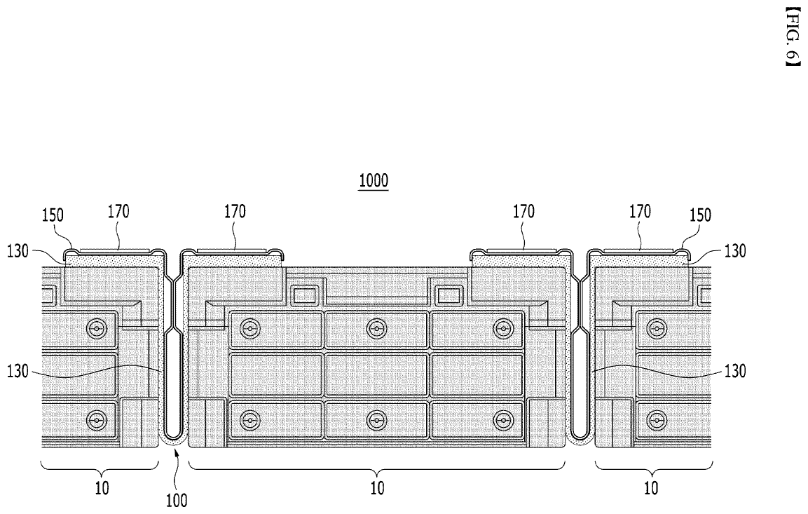

Next, a battery pack according to another embodiment of the present disclosure will be described with reference to FIGS. 6 to 8. Such a battery pack can include all the contents of the heat dissipation member described above.

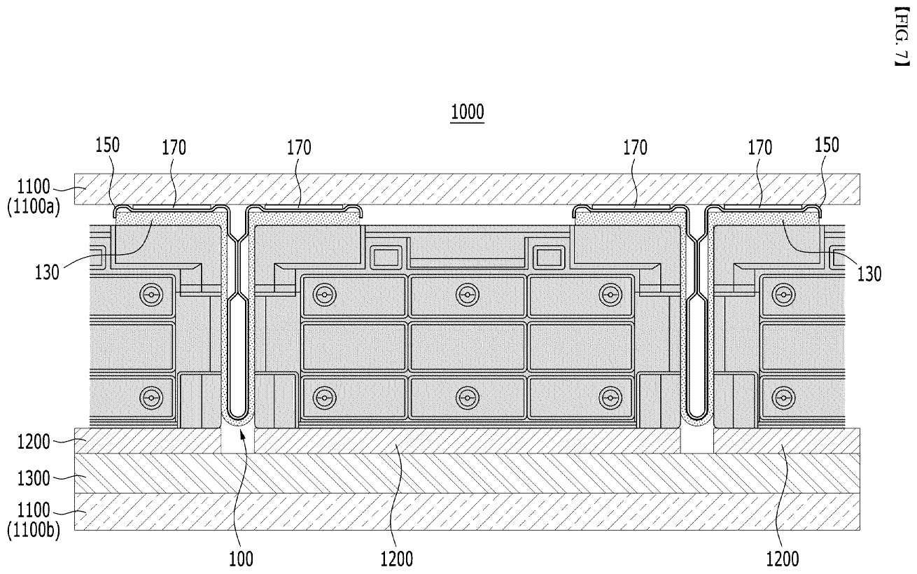

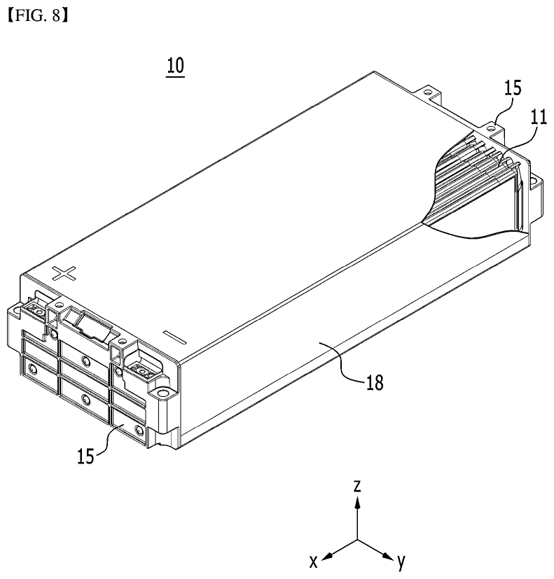

FIG. 6 is a cross section view showing a battery pack according to another embodiment of the present disclosure. FIG. 7 is a cross section diagram showing a battery pack according to another embodiment of the present disclosure. FIG. 8 is a perspective view showing a battery module included in the battery pack of FIGS. 6 and 7.

Referring to FIGS. 6 to 8, the battery pack 1000 according to the present embodiment includes a plurality of battery modules 10, a pack frame 1100 that houses the plurality of battery modules 10, and a heat dissipation member 100 located between adjacent battery modules 10 among a plurality of battery modules 10.

First, referring to FIG. 8, the battery module 10 included in the battery pack 1000 according to the present embodiment may be configured such that a plurality of battery cells 11 are stacked in a preset direction and then mounted in the module frame 18. The plurality of battery cells 11 are not particularly limited in the type thereof, and may be a pouch-type secondary battery or a prismatic secondary battery.

The heat dissipation member 100 may be a heat dissipation member 100 similar to the heat dissipation member 100 described above including all of the features set forth above. The heat dispersion member 150 may include the first heat dispersion part 151 and the second heat dispersion part 152 that are integrally formed, as shown in FIG. 2. The first heat dispersion part 151 and the second heat dispersion part 152 may be formed so as to be partially spaced apart from each other. Therefore, a space may be formed between the first heat dispersion part 151 and the second heat dispersion part 152.

The first heat dispersion part 151 and the second heat dispersion part 152 may be respectively bent and extended, and the directions in which the first heat dispersion part 151 and the second heat dispersion part 152 are bent may be in opposite directions relative to the other. Specifically, the first heat dispersion part 151 may refer to the left area with respect to the center of the heat dispersion member 150 (see FIG. 2), and the second heat dispersion part 152 may refer to the right area. Therefore, as being away from a heat dispersion member 150 in which the first heat dispersion part 151 and the second heat dispersion part 152 are integrated, the first heat dispersion part 151 and the second heat dispersion part 152 may have bent portions. Therefore, as being bent as described above, the first heat dispersion part 151 and the second heat dispersion part 152 may have portions bent and extended in directions opposite to each other. At this time, the portions bent and extended in directions opposite to each other as described above may be located in the battery pack 1000 to be adjacent to the upper part of the battery module 10. That is, the heat dissipation member 100 may be fitted and fixed between the pair of battery modules 10 so that the bent and extended portion of the heat dispersion member 150 is adjacent to the upper part of the battery module 10.

The heat dissipation member 100 according to the present embodiment may further include a first depressed part 156 formed in the first heat dispersion part 151, and a second depressed part 157 formed in the second heat dispersion part 152. At this time, the first depressed part 156 may be formed in the bent and extended portion of the first heat dispersion part 151, and the second depressed part 157 may be formed in the bent and extended portion of the second heat dispersion part 152. In particular, the first depressed part 156 and the second depressed part 157 may be formed to be adjacent to the upper part of the battery module 10.

In addition, the heat dissipation member 100 may further include a first indented part 158 formed in the first heat dispersion part 151, and a second indented part 159 formed in the second heat dispersion part 152. The first indented part 158 and the second indented part 159 may be formed adjacent to the lower end of the heat dispersion member 150 where the first heat dispersion part 151 and the second heat dispersion part 152 are integrated. That is, the first indented part 158 and the second indented part 159 may be formed between the pair of battery modules 10, and more specifically, it may be formed to be adjacent to the side surface part of the module frame 18 of the battery module 10.

The first indented part 158 and the second indented part 159 may be formed to contact each other. While the first indented part 158 and the second indented part 159 contact each other, the heat transferred to the first heat dispersion part 151 or the second heat dispersion part 152 may be rapidly transferred to the other of the first heat dispersion part 151 or second heat dispersion part 152. Thus, the heat dissipation performance of the heat dispersion member 150 can be improved by forming an additional heat transfer path in the heat dispersion member 150 through the contact, together with the heat transfer path through the lower end of the heat dispersion member 150 where the first heat dispersion part 151 and the second heat dispersion part 152 are integrated.

In addition, the heat dispersion member 150 may be made of a material such as aluminum (Al) or graphite. However, the material of the heat dispersion member 150 is not limited thereto, and any material having high thermal conductivity may be included in the present embodiment.

The heat dissipation member 100 according to the present embodiment may further include a cooling member 170 formed in the first depressed part 156 and the second depressed part 157. The cooling member 170 may be a cooling pad. The cooling member 170 can cool the heat transferred from the heat dispersion member 150 of the heat dissipation member 100. Further, the cooling member 170 according to the present embodiment may contact the upper part 1100a of the pack frame 1100. More specifically, the cooling member 170 may contact the inner surface of the upper part 1100a of the pack frame 1100. Therefore, if the battery module 10 catches fire, thermal energy may be rapidly transferred through the heat dissipation member 100 and the upper portion 1100a of the pack frame 1100 and discharged to the outside.

Referring to FIGS. 4 and 5, the heat dissipation member 100 according to the present embodiment may include a heat insulation member 130 that is formed along the outer surface of the heat dispersion member 150. Specifically, the heat insulation member 130 may be formed at a part of the outer surface of the heat dispersion member 150. More specifically, the heat insulation member 130 may be formed on the outer surface of the lower end of the bent and extended portion of the outer surface of the heat dispersion member 150.

Further, the heat insulation member 130 may include a ceramic material. In one example, the ceramic material may include ceramic fibers. However, the material of the heat insulation member 130 is not limited thereto, and any material having high heat insulating properties may be included in the present embodiment.

Further, according to the present embodiment, the heat insulating member 130 of the heat dissipation member 100 may be formed between the heat dispersion member 150 and the battery module 10. More specifically, one side surface of one battery module 10 among the pair of battery modules 10 may contact the heat insulation member 130, and one side surface of another battery module 10 among the pair of battery modules 10 may also be in contact with the heat insulation member 130. Therefore, the heat insulation member 130 may be formed to contact the battery module 10.

Thus, in the present embodiment, when at least one battery module ignites or explodes, heat transfer between adjacent battery modules 10 can be blocked by the heat insulation member 130 of the heat dissipation member 100, thereby preventing continuous ignition or explosion due to heat propagation between adjacent battery modules 10.

In addition, referring to FIG. 7, the battery pack 1000 according to another embodiment of the present disclosure may further include a thermal conductive resin layer 1200 that is formed between the lower part of the battery module 10 and the bottom part 1100b of the pack frame 1100. The battery pack 1000 may further include a heat sink 1300 that is formed between the thermal conductive resin layer 1200 and the bottom part 1100b of the pack frame 1100. Therefore, the heat generated in the battery module 10 can be transferred to not only the heat dissipation member 100 but also the bottom part 1100b of the pack frame 1100 through the thermal conductive resin layer 1200 and the heat sink 1300 to be discharged to the outside.

The battery pack can be applied to various devices. Such a device can be applied to a vehicle such as an electric bike, an electric vehicle, and a hybrid electric vehicle, or other various devices outside the scope of vehicles.

Although preferred embodiments of the present disclosure have been described in detail above, the scope of the present disclosure is not limited thereto, and numerous other modifications and embodiments can be devised by those skilled in the art, without departing from the spirit and scope of the principles of the invention described in the appended claims. Further, these modifications should not be understood individually from the technical spirit or perspective of the present disclosure.

### DESCRIPTION OF REFERENCE NUMERALS

10: battery module
11: battery cell
100: heat dissipation member
130: heat insulation member
150: heat dispersion member
151: first heat dispersion part
152: second heat dispersion part
156: first depressed part
157: second depressed part
158: first indented part
159: second indented part
170: cooling member
1000: battery pack
1100: pack frame
1100a: upper part of the pack frame
1100b: bottom part of the pack frame
1200: thermal conductive resin layer
1300: heat sink

1. A heat dissipation member comprising:
a heat dispersion member including a first heat dispersion part and a second heat dispersion part; and
a heat insulating member disposed on an outer surface of the heat dispersion member.

2. The heat dissipation member according to claim 1 wherein:
the first heat dispersion part and the second heat dispersion part are integrally formed to be partially spaced apart from each other.

3. The heat dissipation member according to claim 1 wherein:
the first heat dispersion part and the second heat dispersion part are both bent and extended such that the first heat dispersion part extends in an opposite direction relative to the second heat dispersion part.

4. The heat dissipation member according to claim 1, further comprising:
a first depressed part formed in the first heat dispersion part, and
a second depressed part formed in the second heat dispersion part.

5. The heat dissipation member according to claim 4, further comprising: a cooling member formed in the first depressed part and the second depressed part.

6. The heat dissipation member according to claim 1, further comprising:
a first indented part formed in the first heat dispersion part; and
a second indented part formed in the second heat dispersion part,
wherein the first indented part contacts the second indented part.

7. A battery pack comprising:
a plurality of battery modules; and
a heat dissipation member located between adjacent battery modules of the plurality of battery modules,
wherein the heat dissipation member comprises:
a heat dispersion member including a first heat dispersion part and a second heat dispersion part; and
a heat insulation member disposed on an outer surface of the heat dispersion member.

8. The battery pack according to claim 7 wherein:
the heat insulation member is disposed between the heat dispersion member and the battery module.

9. The battery pack according to claim 7 wherein:
the heat insulation member contacts the battery module.

10. The battery pack according to claim 7 wherein:
the first heat dispersion part and the second heat dispersion part are integrally formed to be partially spaced apart from each other.

11. The battery pack according to claim 7 wherein:
the first heat dispersion part and the second heat dispersion part are both bent and extended, such that the first heat dispersion part extends in an opposite direction relative to the second heat dispersion part.

12. The battery pack according to claim 7, further comprising:
a first indented part formed in the first heat dispersion part; and
a second indented part formed in the second heat dispersion part,
wherein the first indented part contacts the second indented part.

13. The battery pack according to claim 7, further comprising:
a first depressed part formed in the first heat dispersion part, and
a second depressed part formed in the second heat dispersion part.

14. The battery pack according to claim 13, further comprising:
a cooling member formed in the first depressed part and the second depressed part.

15. The battery pack according to claim 14, further comprising:
a pack frame that houses the plurality of battery modules,
wherein the cooling member contacts an upper part of the pack frame.

16. The battery pack according to claim 15 wherein:
the cooling member contacts an upper inner surface of the pack frame.

17. The battery pack according to claim 15, further comprising:
a thermal conductive resin layer disposed between a lower part of the battery module and a bottom part of the pack frame.

18. The battery pack according to claim 17, further comprising:
a heat sink disposed between a lower part of the thermal conductive resin layer and a bottom part of the pack frame.
